(19) United States
(12) Patent Application Publication
(10) Pub. No.: US 2008/0193685 A1
(43) Pub. Date: Aug. 14, 2008

(54) LITHOGRAPHIC PRINTING PLATE PRECURSOR, LITHOGRAPHIC PRINTING PLATE, AND PROCESS OF MAKING THE SAME

(75) Inventor: Keitaro AOSHIMA, Haibara-gun (JP)

Correspondence Address: SUGHRUE-265550, 2100 PENNSYLVANIA AVE. NW, WASHINGTON, DC, 20037-3213, US

(73) Assignee: FUJIFILM CORPORATION, Tokyo (JP)

(21) Appl. No.: 11/850,225

(22) Filed: Sep. 5, 2007

(30) Foreign Application Priority Data
Sep. 14, 2006 (JP) 2006-249111

(51) Int. Cl. B41M 5/025; B05D 5/04; G01N 21/00

(52) U.S. Cl. 428/32.12; 427/256; 356/237.5

(57) ABSTRACT

A lithographic printing plate precursor on which an image is adapted to be formed with an inkjet ink by inkjet recording, which includes a support and an ink receptive layer containing a luminescent substance.

### FIELD OF THE INVENTION

This invention relates to a lithographic printing plate precursor, a lithographic printing plate, and a process of making the same. More particularly, it relates to a lithographic printing plate precursor on which an image is formed by inkjet recording, a lithographic printing plate prepared therefrom, and a process of producing the lithographic printing plate.

### BACKGROUND OF THE INVENTION

Digitization technology for electronically processing, storing and outputting image information by use of a computer has recently been widespread. A variety of new image output systems that can keep up with such digitization technology have now come to be practical. Under these circumstances, attention has been paid to the computer-to-plate (CTP) technique, in which digitized information is carried on a highly convergent radiation such as a laser beam, and a lithographic printing plate precursor is scan-exposed to the light, thereby to directly manufacture a lithographic printing plate without using a lith film.

A CTP technique using an inkjet recording system is also known in addition to the CTP technique using a laser beam.

JP-A-5-204138 and JP-A-4-69244 disclose processes for making a printing plate comprising forming an image area on a support by inkjet recording using a photo-curable ink composition and exposing the image area to light to cure the ink composition. Inkjet recording is a relatively high-speed image output system, and the equipment therefor is structurally simple because a complicated optical system is unnecessary. Since an image is formed of inkjet ink, there is no need to provide a coating film such as a photosensitive layer on the support on which an image is formed. Accordingly, to adopt the inkjet recording system in lithographic plate making is effective on cost reduction.

Nevertheless, a support with no coating film thereon can be scratched or contaminated during transportation or handling. The support needs a protective film. Various polymer coating films are used as a protective film. The protective film serves as an ink-receptive layer in inkjet recording. If the protective film has coating unevenness, the recorded image dots will fluctuate, leading to reduction of image quality. Therefore, the ink receptive layer requires inspection for coating unevenness. The problem is that a polymer coating film is generally colorless, which makes coating unevenness detection difficult. To address the problem, coloring the ink receptive layer by addition of a colorant is a conceivable solution. However, using a colorant gives rise to another problem as follows.

The non-inkjet-recorded part, namely the nonimage area of the ink receptive layer is removed with a fountain solution. The colorant in the ink receptive layer dissolves out in the fountain solution to color or contaminate the fountain solution.

### SUMMARY OF THE INVENTION

An object of the invention is to provide a lithographic printing plate precursor the ink receptive layer of which is easily inspected for coating unevenness; a lithographic printing plate; and a process of making the lithographic printing plate. Another object of the invention is to provide a method of inspecting the surface condition of a lithographic printing plate precursor.

The present invention provides in its first aspect a lithographic printing plate precursor on which an image is adapted to be formed with an inkjet ink by inkjet recording. The lithographic printing plate precursor includes a support and an ink receptive layer containing a luminescent substance.

The lithographic printing plate precursor preferably contains a water soluble polymer.

The present invention also provides in its second aspect a lithographic printing plate including the lithographic printing plate precursor of the invention and an image formed thereon with an inkjet ink by inkjet jet recording.

The present invention also provides in its third aspect a process of making a lithographic printing plate including the step of forming an image on the lithographic printing plate precursor of the invention with an inkjet ink by inkjet recording.

The present invention also provides in its fourth aspect a method of inspecting the surface condition of the lithographic printing plate precursor of the invention. The method includes irradiating the lithographic printing plate precursor with light causing the luminescent substance to emit light and receiving the emitted light.

### EFFECT OF THE INVENTION

The present invention makes it feasible to easily inspect for coating unevenness of the ink receptive layer thereby to reduce troubles in the manufacture of lithographic printing plates. The lithographic printing plate according to the invention causes no contamination of a fountain solution.

### DETAILED DESCRIPTION OF THE INVENTION

### [I] Ink Receptive Layer

The ink receptive layer that can be used in the invention is non-photosensitive. It contains a luminescent substance as an essential component.

The luminescent substance that can be used in the invention is preferably a compound that absorbs ultraviolet light to emit visible to infrared light. Luminescence may be either fluorescence or phosphorescence. Phosphorescence is preferred for its high responsiveness.

It is preferred for the luminescent compound per se to show no substantial absorption in the visible region. In other words, the compound is preferably imperceptible to the unaided human eye but may have a slight yellow tint.

To avoid smearing during printing, the luminescent substance is preferably water soluble or water dispersible and preferably has an acid, base or salt structure in the molecule thereof.

Examples of the luminescent substance to be used in the invention include fluorescent whitening agents used in paper or fabrics. Specific examples of such fluorescent whitening agents include bis(triazinylamino)stilbenedisulfonic acid derivatives represented by formula (I):

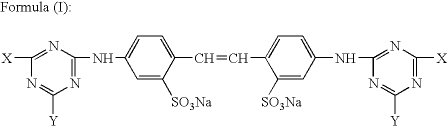

wherein X represents —NH-[benzene], —NH-[benzene]-CH₃, —NH-[benzene]-OCH₃, —NH-[benzene]-SO₃Na, —NH-[benzene]-SO₂NH₂, —OCH₃, —OCH₂CH₂OCH₃, —Cl or —NHCH₃, wherein [benzene] represents a benzene ring structure; and Y represents —NH₂, —NH-[benzene], —OCH₃, —NHCH₃, —NHC₂H₅, —OH, —NH₂CH₂CH₂OH, —N(CH₃)CH₂CH₂OH, —N(CH₂CH₂OH)₂, a morpholino group, or —N(CH₃)CH₂CH₂SO₃H; and bisstyrylbiphenyl derivatives represented by formula (II):

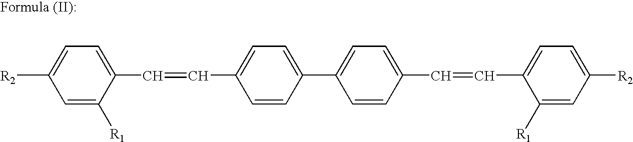

wherein R₁ represents —SO₃Na; and R₂ represents H or Cl.

Further included in preferred luminescent substances are fused ring compounds such as naphthalene derivatives, anthracene derivatives, phenanthrene derivatives, and pyrene derivatives, each of which may have a halogen atom or an alkoxy group as a substituent and preferably has a sulfonic acid form or a salt thereof.

The amount of the luminescent substance to be incorporated into the ink receptive layer is, for example, 0.01% to 90% by weight, preferably 0.1% to 70% by weight, more preferably 0.5% to 50% by weight.

The non-photosensitive ink receptive layer preferably contains a water soluble compound. The water soluble compound that can be used in the invention preferably has water solubility of 1 g or more in 100 g of water at room temperature (e.g., 25° C.). The water soluble compound preferably has film forming properties. In this regard, the water soluble compound is preferably a water soluble polymer with a weight average molecular weight of 1000 or more, still preferably 3000 to 1,000,000. Examples of preferred water soluble polymers include (1) (meth)acrylic resins, styrene resins or modified cellulose each having a carboxyl group or a salt thereof, (2) (meth)acrylic resins, vinyl resins or styrene resins each having a sulfonic acid group or a salt thereof, (3) polymers having an amido group such as polyacrylamide and polyvinylpyrrolidone, (4) polymers having a hydroxyl group such as polyvinyl alcohol, (5) resins having phosphoric acid group or a salt thereof such as the phosphoric acid-modified starch disclosed in JP-A-62-097892, (6) polymers having an onium group (for the details refer to JP-A-2000-10292 and JP-A-2000-108538), (7) polymers having a structural unit typified by poly(p-vinylbenzoic acid) in the molecule thereof, such as p-vinylbenzoic acid/vinylbenzyltriethylammonium salt copolymers and p-vinylbenzoic acid/vinylbenzyltrimethylammonium chloride copolymers, and (8) copolymers comprising a repeating unit containing at least one ethylenically unsaturated bond and a repeating unit containing at least one functional group mutually acting on the surface of a support as described in JP-A-2005-125749.

A coating composition providing the ink receptive layer preferably contains a fluorine-containing or silicon-containing surface active agent to reduce coating unevenness. Known surface active agents can be used.

The aforementioned compounds may be used either individually or in combination of two or more thereof in the coating composition providing the ink receptive layer.

The ink receptive layer is formed in a known manner. For example, the luminescent compound and water soluble compound are dissolved in water, an organic solvent (e.g. methanol, ethanol, methyl ethyl ketone or 1-methoxy-2-propanol) or a mixture thereof in a concentration of 0.005% or 10% by weight to prepare a coating composition, which is applied to a support and dried to form an ink receptive layer on the support.

The ink receptive layer preferably contains the water soluble compound in an amount of 1% to 99% by weight, still preferably 3% to 95% by weight, and preferably has a thickness of 1 to 500 mg/m², still preferably 2 to 250 mg/m².

Coating unevenness, if any, of the ink receptive layer applied onto a support can easily be detected by irradiating the ink receptive layer with a light ray causing the luminescent substance (preferably ultraviolet ray) to emit light and receiving the emitted light. Irradiation with ultraviolet light is carried out using a commercially available black light lamp and the like. Coating unevenness can be detected with the naked eye or with equipment. For example, the light emission from the ink receptive layer is captured into a video camera, etc. and image-processed to inspect for luminescence unevenness of the luminescent substance.

### [II] Support

The support that can be used to make a lithographic printing plate precursor and a lithographic printing plate of the present invention preferably has a surface roughness Ra of 0.1 to 10 μm. Ra is an arithmetic average roughness specified in JIS B0601-1994. A small surface roughness means low adhesion to an image layer (polymerization cured layer), resulting in a short press life. Too large a surface roughness results in the formation of thin parts in the image layer, also leading to a reduced press life. The support for use in the invention is not particularly limited in material as long as it is a sheet or plate with adequate strength, durability, and dimensional stability. Examples of suitable supports include paper, paper laminated with plastic (e.g., polyethylene, polypropylene or polystyrene), a plate of metal (e.g., aluminum, zinc or copper), a film of plastic (e.g., cellulose diacetate, cellulose triacetate, cellulose propionate, cellulose butyrate, cellulose acetate butyrate, cellulose nitrate, polyethylene terephthalate, polyethylene, polystyrene, polypropylene, polycarbonate, or polyvinyl acetate), and paper or plastic film laminated or deposited with metal.

Inter alia, preferred in the present invention are a polyester film and an aluminum plate. An aluminum plate is especially preferred for good dimensional stability and relative inexpensiveness. The term “aluminum plate” as used herein is intended to include a pure aluminum plate, a plate of an aluminum-based alloy containing trace amounts of other elements, and a plastic film laminated with or deposited with aluminum. The other elements making up the aluminum-based alloy include silicon, iron, manganese, copper, magnesium, chromium, zinc, bismuth, nickel, and titanium. The total content of these other elements in the aluminum alloy is 10% by weight at the most. An aluminum support having been subjected to a surface treatment is preferably used in the present invention. In what follows, a preferred aluminum support will be described in more detail.

A pure aluminum plate is particularly preferred in the present invention. In view of refining technological difficulty in obtaining completely pure aluminum, aluminum containing a trace amount of impurity elements will do. Thus, the aluminum plate to be used in the invention is not particularly limited in composition and can be chosen appropriately from plates of aluminum materials known and commonly used in the art. The thickness of the aluminum support is usually about 0.1 to 0.6 mm, preferably 0.15 to 0.4 mm, still preferably 0.15 to 0.3 mm.

According to necessity, the aluminum plate is subjected to a surface treatment, such as graining or anodizing.

If desired, graining is preceded by degreasing (removal of rolling-mill lubricant) using a surface active agent, an organic solvent, an aqueous alkali solution, etc. Aluminum plate graining can be effected by various methods, including mechanical graining, electrochemical graining (electrochemical surface dissolution), chemical graining (selective dissolution of the surface with a chemical), and combinations thereof. Mechanical graining is carried out by ball graining, brushing, sand blasting, buffing, or like techniques. Electrochemical graining is carried out by AC or DC electrolysis in an electrolytic solution containing hydrochloric acid or nitric acid as an electrolyte. A combined graining method as taught in JP-A-54-63902 is also useful.

The aluminum plate is preferably subjected to surface treatment to have the above-recited surface profile (grain structure). The support for use in the invention is obtained by subjecting the aluminum plate to a graining treatment and an anodizing treatment. This does not mean that the process of preparing the aluminum support is particularly limited, and the process may include other various steps than the graining treatment and the anodizing treatment. Typical surface treatment strategies for achieving the recited surface profile (grain structure) include, but are not limited to, (1) a process comprising, in sequence, mechanical graining, alkali etching, acid desmutting, and electrochemical graining, (2) a process comprising mechanical graining, alkali etching, acid desmutting, and repetition of electrochemical graining using different electrolytic solutions, (3) a process comprising, in sequence, alkali etching, acid desmutting, and electrochemical graining using an electrolytic solution, and (4) a process comprising alkali etching, acid desmutting, and a repetition of electrochemical graining using different electrolytes. In these treatments, the electrochemical graining may be followed by alkali etching and acid desmutting. The aluminum support prepared by these surface treatment processes has such a grain structure as contains two or more superimposed surface profiles of different frequencies. A lithographic printing plate obtained by using such an aluminum support is excellent in anti-smearing properties and press life. Each of the surface treatments will be described in greater detail.

### (1) Mechanical Graining

Mechanical graining is an effective means for creating a surface roughness with an average wavelength of 5 to 100 μm at a lower cost than by electrochemical graining. Suitable mechanical graining techniques include wire brush graining in which the surface of the aluminum plate is scratched by metal wire, ball graining in which graining balls and an abrasive are used, and brush graining in which a nylon brush and an abrasive are used as taught in JP-A-6-135175 and JP-B-50-40047. A transfer method is also useful, in which an uneven surface profile is transferred to the aluminum plate. For the details of the transfer method, refer to JP-A-55-74898, JP-A-60-36195, and JP-A-60-203496. Reference can also be made in JP-A-6-55871 disclosing a transfer method in which unevenness transfer is conducted several times and in JP-A-6-24168 disclosing a transfer method characterized in that the uneven surface to be transferred has elasticity.

Also included in transfer methods are a method including repeatedly performing unevenness transfer by use of a transfer roll having fine unevenness formed on its surface by electric discharging, shot blasting, laser machining or plasma etching and a method of bringing an aluminum plate into contact with a surface having fine particles applied thereto to form an uneven pattern, applying a pressure thereon several times thereby to transfer the uneven pattern corresponding to the average diameter of the fine particles onto the aluminum plate repeatedly. A transfer roll having fine unevenness is obtainable by known methods described, e.g., in JP-A-3-8635, JP-A-3-66404, JP-A-63-65017. Fine parallel grooves may be cut on the surface of a roll in two directions by use of a die, a cutting tool or a laser to form rectangular unevenness on the surface. The thus engraved roll surface may be treated, for example, by etching so as to round the formed rectangular unevenness. The transfer roll may be subjected to quenching or plated with hard chromium to have increased surface hardness. Mechanical graining can also be effected by the method disclosed in JP-A-61-162351 and JP-A-63-104889. From the standpoint of productivity, the above described various mechanical graining techniques may be used in combination. It is preferred to carry out the mechanical graining before electrochemical graining.

### (2) Electrochemical Graining

Electrochemical graining is carried out in an electrolyte used in ordinary electrochemical graining using an alternating current. A characteristic uneven surface profile can be formed by using an electrolyte mainly comprising hydrochloric acid or nitric acid. In the present invention, electrochemical graining is preferably performed in two-stage electrolysis in an acidic solution by applying an alternating electric current before and after cathodic electrolysis. By cathodic electrolysis, hydrogen gas evolves on the surface of an aluminum plate to produce smut, whereby the surface condition becomes uniform, which helps the subsequent electrolysis using an alternating electric current to accomplish uniform graining. The electrolytic graining is carried out in accordance with, for example, the electrochemical (or electrolytic) graining technique described in JP-B-48-28123 and British Patent 896,563. While the electrolytic graining described is conducted using a sinusoidal alternating electric current, a special waveform like the one described in JP-A-52-58602 may be used. The waveform described in JP-A-3-79799 is also useful. Other methods that are applicable to carry out electrolytic graining include those described in JP-A-55-158298, JP-A-56-28898, JP-A-52-58602, JP-A-52-152302, JP-A-54-85802, JP-A-60-190392, JP-A-58-120531, JP-A-63-176187, JP-A-1-5889, JP-A-1-280590, JP-A-1-118489, JP-A-1-148592, JP-A-1-178496, JP-A-1-188315, JP-A-1-154797, JP-A-2-235794, JP-A-3-260100, JP-A-3-253600, JP-A-4-72079, JP-A-4-72098, JP-A-3-267400 and JP-A-1-141094. It is also possible to carry out electrolysis using an alternating electric current having a specific frequency that has been proposed for use in the production of electrolytic capacitors as described, e.g., in U.S. Pat. Nos. 4,276,129 and 4,676,879.

Various electrolytic cells and electric sources have been proposed for use in electrolytic graining. Those described in the following literature are employable: U.S. Pat. No. 4,203,637, JP-A-56-123400, JP-A-57-59770, JP-A-53-12738, JP-A-53-32821, JP-A-53-32822, JP-A-53-32823, JP-A-55-122896, JP-A-55-132884, JP-A-62-127500, JP-A-1-52100, JP-A-1-52098, JP-A-60-67700, JP-A-1-230800, JP-A-3-257199, JP-A-52-58602, JP-A-52-152302, JP-A-53-12738, JP-A-53-12739, JP-A-53-32821, JP-A-53-32822, JP-A-53-32833, JP-A-53-32824, JP-A-53-32825, JP-A-54-85802, JP-A-55-122896, JP-A-55-132884, JP-B-48-28123, JP-B-51-7081, JP-A-52-133838, JP-A-52-133840, JP-A-52-133844, JP-A-52-133845, JP-A-53-149135 and JP-A-54-146234.

Examples of the acidic solution can be used as an electrolyte include, in addition to nitric acid and hydrochloric acid recited above, those described in U.S. Pat. Nos. 4,671,859, 4,661,219, 4,618,405, 4,600,482, 4,566,960, 4,566,958, 4,566,959, 4,416,972, 4,374,710, 4,336,113 and 4,184,932.

In using a nitric acid-based electrolyte, pits having an average opening diameter of 0.5 to 5 μm can be formed. When a relatively large quantity of electricity is applied, the electrolysis is concentrated to make honeycomb pits exceeding 5 μm. To obtain such a grain structure, the total quantity of electricity that has been applied to carry out the anode reaction of the aluminum plate by the time of completion of the electrolytic reaction is preferably 1 to 1000 C/dm², still preferably 50 to 300 C/dm². The current density is preferably 20 to 100 A/dm². A small waviness having an average opening diameter of 0.2 μm or smaller can be formed by using a high concentration or high temperature nitric acid electrolyte.

Having per se strong dissolving power for aluminum, hydrochloric acid when used as an electrolyte is capable of forming fine surface unevenness by slight electrolysis. A fine surface unevenness having an average opening diameter of 0.01 to 0.2 μm can be uniformly formed over the entire surface of an aluminum plate. To obtain such a grain structure, the total quantity of electricity that has been applied to carry out the anode reaction of the aluminum plate by the time of completion of the electrolytic reaction is preferably 1 to 100 C/dm², still preferably 20 to 70 C/dm². The current density is preferably 20 to 50 A/dm².

In electrochemical graining using a hydrochloric acid-based electrolyte, the total electricity quantity to be applied to perform the anode reaction may be increased to 400 to 1000 C/dm² thereby to form crater-like large waviness at the same time. In this case, fine unevenness having an average opening diameter of 0.01 to 0.4 μm and crater-like waviness having an average opening diameter of 10 to 30 μm are superimposedly formed over the entire area of the aluminum plate.

### (3) Alkali Etching

Alkali etching is a treatment in which the aluminum plate is brought into contact with an alkali solution to dissolve the skin layer of the aluminum plate.

In the case where the aluminum plate is not mechanically grained, alkali etching that is conducted before electrochemical graining is to remove a rolling-mill lubricant (in the case of a rolled aluminum plate), dirt, natural oxide film, and the like from the surface of the aluminum plate. In the case of the aluminum plate that has been mechanically grained, alkali etching before electrochemical graining is to round off the sharp edges of the surface unevenness resulting from the mechanical graining.

When alkali etching is not preceded by mechanical graining, the amount of etching (the amount of aluminum etched away) is preferably 0.1 to 10 g/m², still preferably 1 to 5 g/m². When this amount of etching is less than 0.1 g/m², the surface rolling-mill lubricant, dirt, natural oxide film, etc. can remain, resulting in a failure to form uniform pits in second stage electrolytic graining. When the amount of etching is within the recited preferred range, the rolling-mill lubricant, dirt, natural oxide film, etc. can sufficiently be removed from the surface. Etching to a degree higher than 10 g/m² only results in economical disadvantage.

In the case when alkali etching is preceded by mechanical graining, the amount of etching is preferably 3 to 20 g/m², still preferably 5 to 15 g/m². When that amount is less than 3 g/m², the etching treatment can fail to round off the sharp unevenness formed by the mechanical graining, or the second stage electrolytic graining can fail to form uniform pits, or printing using the resulting lithographic printing plate can involve accelerated smearing. When the amount of etching exceeds 20 g/m², the surface unevenness can disappear.

Alkali etching directly following electrolytic graining is to dissolve the smut generated in the acidic electrolyte and to dissolve the edges of the pits formed by the electrolytic graining. A preferred amount of etching varies because the pit structure formed by electrolytic graining varies depending on the electrolyte used. Generally, the amount of etching in alkali etching conducted after electrolytic graining preferably ranges from 0.1 to 5 g/m². In the case of using a nitric acid-based electrolyte in the electrolytic graining, the etching amount should be somewhat larger than that in the case of using a hydrochloric acid-based electrolyte. In the case where electrolytic graining is repeated, every electrolytic graining treatment may be followed by alkali etching if needed.

Examples of the alkali that can be used in the alkali etchant include caustic alkalis and alkali metal salts. Specific examples of caustic alkalis are caustic soda and caustic potash. Specific examples of alkali metal salts include alkali metal silicates, such as sodium metasilicate, sodium silicate, potassium metasilicate, and potassium silicate; alkali metal carbonates, such as sodium carbonate and potassium carbonate; alkali metal aluminates, such as sodium aluminate and potassium aluminate; alkali metal aldonates, such as sodium gluconate and potassium gluconate; and alkali metal hydrogenphosphates, such as sodium secondary phosphate, potassium secondary phosphate, sodium tertiary phosphate, and potassium tertiary phosphate. Inter alia, a caustic alkali solution or a solution containing a caustic alkali and an alkali metal aluminate is preferred for high etching rate and inexpensiveness. A caustic alkali aqueous solution is particularly preferred.

### (4) Desmutting

Electrolytic graining or alkali etching is followed by pickling (Desmutting) to remove smut remaining on the aluminum plate surface. Examples of the acid to be used for desmutting include nitric acid, sulfuric acid, phosphoric acid, chromic acid, hydrofluoric acid, and fluoroboric acid. Desmutting is carried out by bringing the aluminum plate into contact with an acidic solution containing 0.5% to 30% by weight of hydrochloric acid, nitric acid, sulfuric acid, etc. (containing 0.01% to 5% by weight of an aluminum ion). The contact between the aluminum plate and the acidic solution is achieved by passing the aluminum plate through a tank filled with the acidic solution, dipping the aluminum plate in a tank filled with the acidic solution or spraying the acidic solution to the aluminum plate. Nitric acid- or hydrochloric acid-based waste liquid discharged from the above described electrolytic graining unit or sulfuric acid-based waste liquid from an anodizing unit hereinafter described can be used as the acidic solution in the desmutting. The desmutting is preferably conducted at a liquid temperature of 25° to 90° C. for 1 to 180 seconds. The acidic solution used for desmutting may have aluminum or an aluminum alloy component dissolved therein.

### (5) Anodizing

Where necessary, the thus grained aluminum plate is subjected to alkali etching followed by neutralization. The aluminum plate is then subjected to anodizing where it is desired to increase the surface water receptivity and wear resistance. Various electrolytes capable of forming a porous oxide film (anodized layer) are useful to effect anodizing. Sulfuric acid, phosphoric acid, oxalic acid, chromic acid or a mixture thereof is usually employed. The concentration of the electrolyte is decided as appropriate for the type of the electrolyte used.

While the conditions for anodizing depend on the electrolyte, satisfactory results are obtained under the following conditions: electrolyte's concentration, 1% to 80% by weight; liquid temperature, 5° to 70° C.; current density, 5 to 60 A/dm²; voltage, 1 to 100 V; and electrolysis time, 10 seconds to 5 minutes. The anodized layer thickness is suitably 2.0 g/m². When it is less than 2.0 g/m², the resulting lithographic printing plate is easily scratched on its nonimage area, which can cause ink smearing (ink adhesion to the nonimage area).

### (6) Hydrophilization

Although the anodized layer works as a water wettable (hydrophilic) surface, it is preferably subjected to further hydrophilization. The term “water wettable (or hydrophilic)” means having a water contact angle smaller than 10°, preferably smaller than 5°. Hydrophilization is preferably such that a hydrophilizing compound is adsorbed onto the anodized layer.

Examples of suitable hydrophilization treatments include potassium fluorozirconate treatment (see U.S. Pat. No. 2,946,638), phosphomolybdate treatment (see U.S. Pat. No. 3,201,247), alkyl titanate treatment (see British Patent 1,108,559), polyacrylic acid treatment (see German Patent 1,091,433), polyvinylphosphonic acid treatment (see German Patent 1,134,093 and British Patent 1,230,447), phosphonic acid treatment (see JP-B-44-6409), phytic acid treatment (see U.S. Pat. No. 3,307,951), treatment with a divalent metal salt of a lipophilic organic polymer (see JP-A-58-16893 and JP-A-58-18291), and immersing in a polysulfonic acid compound such as Tamol.

Hydrophilization can also be achieved by providing an undercoat using a phosphate (see JP-A-62-19494), a water soluble epoxy compound (see JP-A-62-33692), a phosphoric acid-modified starch (see JP-A-62-97892), a diamine compound (see JP-A-63-56498), an organic or inorganic acid salt of an amino acid (see JP-A-63-130391), an organic phosphonic acid containing a carboxyl group or a hydroxyl group (see JP-A-63-145092) a compound having an amino group and a phosphonic acid group (see JP-A-63-165183), a specific carboxylic acid derivative (see JP-A-2-316290), a phosphoric ester (see JP-A-3-215095), a compound having one amino group and one phosphorus oxyacid group (see JP-A-3-261592), an aliphatic or aromatic phosphonic acid, e.g., phenylphosphonic acid (see JP-A-5-246171), a sulfur-containing compound, e.g., thiosalicylic acid (see JP-A-1-307745), a compound having a phosphorus oxyacid group (see JP-A-4-282637), and so forth. Coloring using an acid dye as described in JP-A-60-64352 is adoptable.

Hydrophilization is preferred achieved by treating with an aqueous solution of an alkali metal silicate, such as sodium silicate or potassium silicate, by, for example, immersion.

The amount of silicon to be adhered is preferably 1.0 to 20.0 mg/m², still preferably 2.0 to 17.0 mg/m². With this amount being 1.0 mg/m² or more, the resulting lithographic printing plate exhibits good resistance to smearing. With the amount of silicon being 20.0 mg/m² or less, a lithographic printing plate with a long press life, particularly after a burning-in treatment, can be obtained.

Each of the aforementioned surface treatments is preferably followed by washing with water. Pure water, well water, tap water or like water can be used in the washing. In order to prevent carryover of a treating solution from the precedent treatment into the next, the plate may be squeegeed between nip rollers.

In place of the aluminum support, a polyester film or paper support having an appropriate coating layer on its surface is also suitably used in the present invention. Such a support is exemplified by the support disclosed in JP-A 2003-118254 that has a coating layer comprising porous filler particles and a binder system containing a composite of a resin having a metal atom and/or a semimetal atom bonded thereto via an oxygen atom and a specific polymer and the support disclosed in JP-A-2003-19873 that has a coating layer comprising (1) porous filler particles, (2) at least one metal alcoholate compound selected from a metal alcoholate, a chelate compound obtained by the reaction between the metal alcoholate and a β-diketone and/or a β-ketoester, and a partial hydrolysis product obtained by allowing the chelate compound to react with water, and (3) a binder system containing a composite of a resin having a metal atom and/or a semimetal atom bonded thereto via an oxygen atom and an organic polymer capable of forming a hydrogen bond with the resin.

### [III] Ink

The inkjet ink that can be used in the present invention is not particularly limited. Various inks can be used, including aqueous inks that are solutions or dispersions of a polymer or a colorant in water, solvent inks that are solutions or dispersions of a polymer or a colorant in an organic solvent, and radiation curable inks containing a compound curable on irradiation with a radiation. Radiation curable inks are preferred in terms of press life. Photopolymerizable inks containing a fluorine-containing compound hereinafter described are particularly preferred.

The fluorine-containing compound used in the photopolymerizable ink is preferably a compound containing one to three fluorine atoms per molecule. More preferred is a compound containing one to three fluorine atoms and a polymerizable group per molecule or a polymerization product of the compound.

Examples of the polymerizable group possessed by the fluorine-containing compound include a radically polymerizable, ethylenically unsaturated double bond, a cationically polymerizable cyclic ether group, and a cationically polymerizable cyclic ester group.

Particularly preferred examples of the fluorine-containing compound include the following compounds (1) through (4).

(1) A fluoro-aliphatic group-containing monomer represented by formula (III) or a copolymer containing a repeating unit derived from the monomer (III) and a repeating unit derived from polyoxyalkylene acrylate and/or polyoxyalkylene methacrylate. The copolymer is preferred. The monomer and the copolymer are disclosed in JP-A-2002-311577.

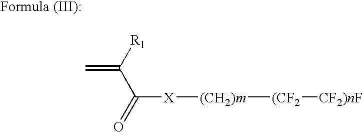

wherein R₁ represents a hydrogen atom or a methyl group; X represents an oxygen atom, a sulfur atom or —N(R₂)—; m represents an integer of 1 to 6; n represents an integer of 2 or 3; and R₂ represents a hydrogen atom or an alkyl group having 1 to 4 carbon atoms.
(2) A fluoroalkyl (meth)acrylate monomer represented by formula (IV) or (V) or a copolymer containing a repeating unit derived from the monomer (IV) or (V) and a repeating unit derived from a polyoxyalkylene group-containing, ethylenically unsaturated monomer. The copolymer is preferred. The monomer and the copolymer are disclosed in JP-A-2003-221419.

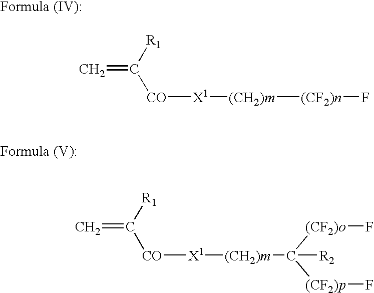

wherein X¹ represents an oxygen atom or —NR³—; R¹ represents a hydrogen atom or a methyl group; R³ represents a hydrogen atom, a substituted or unsubstituted alkyl group having 1 to 12 carbon atoms, a substituted or unsubstituted cycloalkyl group having 3 to 12 carbon atoms, a substituted or unsubstituted aryl group having 6 to 12 carbon atoms, or a substituted or unsubstituted aralkyl group having 6 to 24 carbon atoms; R² represents a hydrogen atom or a fluorine atom; m represents an integer of 0 to 10; n represents an integer of 2 or 3; and o and p each represent 1 or 2.
(3) A fluoroalkyl (meth)acrylate monomer represented by formula (VI) or a copolymer containing a repeating unit derived from the monomer (VI) and a repeating unit derived from a polyoxyalkylene group-containing, ethylenically unsaturated monomer. The copolymer is preferred. The monomer and the copolymer are disclosed in JP-A-2004-101893.

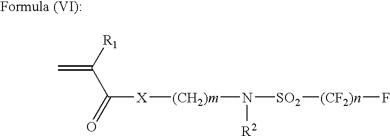

wherein X represents an oxygen atom or —NR³—; R¹ represents a hydrogen atom or a methyl group; R² represents a hydrogen atom, a substituted or unsubstituted alkyl group having 1 to 12 carbon atoms, a substituted or unsubstituted cycloalkyl group having 3 to 12 carbon atoms, a substituted or unsubstituted aryl group having 6 to 12 carbon atoms, or a substituted or unsubstituted aralkyl group having 6 to 24 carbon atoms; R³ represents a hydrogen atom, a substituted or unsubstituted alkyl group having 1 to 12 carbon atoms, a substituted or unsubstituted cycloalkyl group having 3 to 12 carbon atoms, a substituted or unsubstituted aryl group having 6 to 12 carbon atoms, or a substituted or unsubstituted aralkyl group having 6 to 24 carbon atoms; m represents an integer of 1 to 10; and n represents an integer of 1 to 4.
(4) A polymer having a group represented by formula (VII) on its side chain. The polymer is disclosed in JP-A-2004-107589.

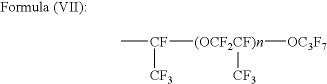

wherein n represents an integer of 0 to 10.

The polymers described in (1) to (4) above preferably have a weight average molecular weight of 3000 to 200,000, still preferably 6,000 to 80,000. The polyoxyalkylene group is represented by (OR)ₓ, wherein R is an alkylene group having 2 to 4 carbon atoms, preferably —CH₂CH₂—, —CH₂CH₂CH₂—, —CH(CH₃)CH₂—, —CH₂CH₂CH₂CH₂— or —CH(CH₃)CH(CH₃)—; and x is a positive integer, preferably an integer of 2 to 50, still preferably 3 to 30. When x is 2 or greater, the R's may be the same or different.

The amount of the fluorine-containing compound in the photopolymerizable ink is preferably 0.001% to 10% by weight, still preferably 0.01% to 5% by weight.

Photopolymerization initiators known for radical or cationic polymerization can be suitably used in the present invention. These photopolymerization initiators may be used in combination with other photo initiators including compounds that undergo chemical change by the action of light or by the mutual action of a sensitizing dye in its electron-excited state to produce at least one of a radical, an acid, and a base. Any photopolymerization initiators known in the art can be used with no limitation. Specific examples of suitable photopolymerization initiators include aromatic ketones, benzoin, benzoin derivatives, e.g., benzoin ether, acylphosphine oxide compounds, onium salts, e.g., sulfonium salts and iodonium salts, organic peroxides, hexaaryllbiimidazole compounds, ketoxime esters, borate salts, azinium salts, metallocene compounds, and compounds having a carbon-halogen bond. While these compounds exhibit polymerization initiating performance mostly in the ultraviolet region, they can be spectrally sensitized to visible light or infrared light by being combined with an appropriate sensitizer.

The amount of the polymerization initiator in the photopolymerizable ink is preferably 0.01% to 30% by weight, still preferably 0.1% to 20% by weight.

Polymerizable compounds that can suitably be used in the invention include known radically and/or cationically polymerizable monomers and oligomers. Examples are (meth)acrylates, (meth)acrylamides, (meth)acrylic acid, maleic acid and its derivatives, styrenes, olefins, vinyl ethers, vinyl esters, epoxy compounds, oxetane compounds, and cyclic esters.

### (A) Radically Polymerizable Monomers

Examples of monofunctional (meth)acrylates include hexyl (meth)acrylate, 2-ethylhexyl (meth)acrylate, tert-octyl (meth)acrylate, isoamyl (meth)acrylate, decyl (meth)acrylate, isodecyl (meth)acrylate, stearyl (meth)acrylate, isostearyl (meth)acrylate, cyclohexyl (meth)acrylate, 4-n-butylcyclohexyl (meth)acrylate, bornyl (meth)acrylate, isobornyl (meth)acrylate, benzyl (meth)acrylate, 2-ethylhexyl diglycol (meth)acrylate, butoxyethyl (meth)acrylate, 2-chloroethyl (meth)acrylate, 4-bromobutyl (meth)acrylate, cyanoethyl (meth)acrylate, butoxymethyl (meth)acrylate, 3-methoxybutyl (meth)acrylate, alkoxymethyl (meth)acrylates, alkoxyethyl (meth)acrylates, 2-2-(methoxyethoxy)ethyl (meth)acrylate, 2-(2-butoxyethoxy)ethyl (meth)acrylate, 2,2,2-tetrafluoroethyl (meth)acrylate, 1H,1H,2H,2H-perfluorodecyl (meth)acrylate, 4-butylphenyl (meth)acrylate, phenyl (meth)acrylate, 2,4,5-tetramethylphenyl (meth)acrylate, 4-chlorophenyl (meth)acrylate, phenoxymethyl (meth)acrylate, phenoxyethyl (meth)acrylate, glycidyl (meth)acrylate, glycidyloxybutyl (meth)acrylate, glycidyloxyethyl (meth)acrylate, glycidyloxypropyl (meth)acrylate, tetrahydrofurfuryl (meth)acrylate, hydroxyalkyl (meth)acrylates (e.g., 2-hydroxyethyl (meth)acrylate, 3-hydroxypropyl (meth)acrylate, 2-hydroxypropyl (meth)acrylate, 2-hydroxybutyl (meth)acrylate, 4-hydroxybutyl (meth)acrylate, and 3-hydroxypropyl (meth)acrylate), dimethylaminoethyl (meth)acrylate, diethylaminoethyl (meth)acrylate, dimethylaminopropyl (meth)acrylate, diethylaminopropyl (meth)acrylate, trimethoxysilylpropyl (meth)acrylate, trimethylsilylpropyl (meth)acrylate, polyethylene oxide (meth)acrylate, oligoethylene oxide (meth)acrylate, oligoethylene oxide monoalkyl ether (meth)acrylates (e.g., oligoethylene oxide monomethyl ether (meth)acrylate), polyethylene oxide monoalkyl ether (meth)acrylates (e.g., polyethylene oxide monomethyl ether (meth)acrylate), dipropylene glycol meth)acrylate, polypropylene oxide monoalkyl ether (meth)acrylates, oligopropylene oxide monoalkyl ether (meth)acrylates, 2-methacryloyloxyethylsuccinic acid, 2-methacryloyloxyhexahydrophthalic acid, 2-methacryloyloxyethyl-2-hydroxypropyl phthalate, butoxydiethyleneglycol (meth)acrylate, trifluoroethyl (meth)acrylate, perfluorooctyl ethyl (meth)acrylate, 2-hydroxy-3-phenoxypropyl (meth)acrylate, EO-modified phenol (meth)acrylate, EO-modified cresol (meth)acrylate, EO-modifiednonylphenol (meth)acrylate, PO-modified nonylphenol (meth)acrylate, and EO-modified 2-ethylhexyl (meth)acrylate.

Examples of bifunctional (meth)acrylates include 1,6-hexanediol di(meth)acrylate, 1,10-decanediol di(meth)acrylate, neopentyl glycol di(meth)acrylate, 2,4-dimethyl-1,5-pentanediol di(meth)acrylate, butylethylpropanediol (meth)acrylate, ethoxylated cyclohexanemethanol di(meth)acrylate, polyethylene glycol di(meth)acrylate, oligoethylene glycol di(meth)acrylate, ethylene glycol di(meth)acrylate, 2-ethyl-2-butyl-butanediol di(meth)acrylate, hydroxypivalic acid neopentyl glycol di(methacrylate), EO-modified bisphenol A di(meth)acrylate, bisphenol F polyethoxydi(meth)acrylate, polypropylene glycol di(meth)acrylate, oligopropylene glycol di(meth)acrylate, 1,4-butanediol di(meth)acrylate, 2-ethyl-2-butylpropanediol di(meth)acrylate, 1,9-nonanediol di(meth)acrylate, propoxylated ethoxylated bisphenol A di(meth)acrylate, and tricyclodecane di(meth)acrylate.

Examples of trifunctional (meth)acrylates include trimethylolpropane tri(meth)acrylate, trimethylolethane tri(meth)acrylate, trimethylolpropane alkylene oxide-modified tri(meth)acrylate, pentaerythritol tri(meth)acrylate, dipentaerythritol tri(meth)acrylate, trimethylolpropane tri((meth)acryloyloxypropyl)ether, isocyanuric acid alkylene oxide-modified tri(meth)acrylate, propionic acid dipentaerythritol tri(meth)acrylate, tri((meth)acryloyloxyethyl) isocyanurate, hydroxypivaldehyde-modified dimethylolpropane tri(meth)acrylate, sorbitol tri(meth)acrylate, propoxylated trimethylolpropane tri(meth)acrylate, and ethoxylated glycerol triacrylate.

Examples of tetrafunctional (meth)acrylates include pentaerythritol tetra(meth)acrylate, sorbitol tetra(meth)acrylate, ditrimethylolpropane tetra(meth)acrylate, propionic acid dipentaerythritol tetra(meth)acrylate, and ethoxylated pentaerythritol tetra(meth)acrylate.

Examples of pentafunctional (meth)acrylates include sorbitol penta(meth)acrylate and dipentaerythritol penta(meth)acrylate.

Examples of hexafunctional (meth)acrylates include dipentaerythritol hexa(meth)acrylate, sorbitol hexa(meth)acrylate, phosphazene alkylene oxide-modified hexa(meth)acrylate, and caprolactone-modified dipentaerythritol hexa(meth)acrylate.

As used herein, the term “(meth)acrylate” refers to either acrylate, methacrylate, or a mixture of acrylate and methacrylate.

Examples of (meth)acrylamides include (meth)acrylamide, N-methyl(meth)acrylamide, N-ethyl(meth)acrylamide, N-propyl(meth)acrylamide, N-n-butyl(meth)acrylamide, N-t-butyl(meth)acrylamide, N-butoxymethyl(meth)acrylamide, N-isopropyl(meth)acrylamide, N-methylol(meth)acrylamide, N,N-dimethyl(meth)acrylamide, N,N-diethyl(meth)acrylamide, and (meth)acryloylmorpholine. As used herein, the term “(meth)acrylamide” refers to either acrylamide, methacrylamide, or a mixture of acrylamide and methacrylamide.

Examples of olefins include dicyclopentadiene, ethylene, propylene, 1-butene, 1-pentene, vinyl chloride, vinylidene chloride, isoprene, chloroprene, butadiene, 2,3-dimethylbutadiene, and cyclohexadiene.

Examples of styrenes include styrene, methylstyrene, dimethylstyrene, trimethylstyrene, ethylstyrene, isopropylstyrene, chloromethylstyrene, methoxystyrene, acetoxystyrene, chlorostyrene, dichlorostyrene, bromostyrene, methyl vinylbenzoate, 3-methylstyrene, 4-methylstyrene, 3-ethylstyrene, 4-ethylstyrene, 3-propylstyrene, 4-propylstyrene, 3-butylstyrene, 4-butylstyrene, 3-hexylstyrene, 4-hexylstyrene, 3-octylstyrene, 4-octylstyrene, 3-(2-ethylhexyl)styrene, 4-(2-ethylhexyl)styrene, allylstyrene, isopropenylstyrene, butenylstyrene, octenylstyrene, 4-t-butoxycarbonylstyrene, 4-methoxystyrene, and 4-t-butoxystyrene.

Examples of vinyl ethers include methyl vinyl ether, butyl vinyl ether, hexyl vinyl ether, methoxyvinyl ether, 2-ethylhexyl vinyl ether, methoxyethyl vinyl ether, cyclohexyl vinyl ether, chloroethyl vinyl ether, and triethylene glycol divinyl ether.

Other radically polymerizable monomers include butyl crotonate, hexyl crotonate, dimethyl itaconate, dibutyl itaconate, diethyl maleate, dimethyl maleate, dibutyl maleate, diethyl fumarate, dimethyl fumarate, methyl vinyl ketone, phenyl vinyl ketone, methoxyethyl vinyl ketone, N-vinyloxazolidone, N-vinylpyrrolidone, vinylformamide, vinylidene chloride, methylene malononitrile, vinylidene, diphenyl-2-acryloyloxyethyl phosphate, diphenyl-2-methacryloyloxyethyl phosphate, dibutyl-2-acryloyloxyethyl phosphate, dioctyl-2-methacryloyloxyethyl phosphate, vinyl acetate, vinyl benzoate, and N-vinylcarbazole.

### (B) Cationically Polymerizable Monomers

Cationically polymerizable monomers include oxetanes and epoxy compounds. Examples of the oxetanes include 3-ethyl-3-(hydroxymethyl)oxetane, 3-ethyl-3-(phenoxymethyl)oxetane, 3-ethyl-3-(2-ethylhexyloxymethyl)oxetane, bis[1-ethyl(3-oxetanyl)methyl]ether, bis[1-ethyl(3-oxetanyl)methyl]xylylene ether.

Examples of the epoxy compounds include (3′,4′-epoxycyclohexane)methyl-3,4-epoxycyclohexane carboxylate, 1,2,8,9-diepoxylimonene, and bisphenol A diglycidyl ether.

### (C) Radically and Cationically Polymerizable Monomers

Examples of radically and cationically polymerizable monomers include 4-vinylcyclohexene 1,2-epoxide, 3-ethyl-3-(acryloyloxymethyl)oxetane, and 3-ethyl-3-(methacryloyloxymethyl)oxetane.

The photopolymerizable ink contains the polymerizable compound in an amount preferably of 10% to 99% by weight, still preferably 30% to 95% by weight.

The photopolymerizable ink may be colored to make an image area easily visible. Known dyes or pigments can be used for coloring. The ink may further contain a surface active agent for improving ejection properties, a polymerization inhibitor for improving storage stability. The ink may furthermore contain various polymers for improving mechanical characteristics of an image layer formed of the ink. Examples of such polymers include (meth)acrylic polymers, polyurethane resins, polyamide resins, polyester resins, epoxy resins, phenol resins, polycarbonate resins, polyvinyl butyral resins, polyvinyl formal resins, polyvinyl alcohol, polyethylene glycol, polyethylene oxide, polypropylene glycol, shellac resins, vinyl resins, rubbery resins, waxes, and other natural resins.

In the present invention, transparent inks containing no colorant can be used. By using a colorant-free ink, inkjet recording apparatus will have improved ink ejection properties.

In the present invention, either a solvent-free ink as described above or an aqueous or solvent ink containing water or an organic solvent can be used. Examples of suitable organic solvents include ketones such as acetone and methyl ethyl ketone, alcohols such as methanol, ethanol, propanol, 1-methoxy-2-propanol, ethyleneglycol, diethyleneglycol, dipropyleneglycol, diethylene glycolmonoethyl ether, tripropylene glycol, and tripropylene glycol monomethyl ether, aromatic solvents such as toluene, esters such as ethyl acetate, butyl acetate, isopropyl acetate, and γ-butyrolactone, ethers such as tetrahydrofuran and diethylene glycol diethyl ether, and hydrocarbons such as Isomer G (available from Exxon).

### [IV] Inkjet Recording

The inkjet ink preferably has a viscosity of 20 to 100 mPa·s at 25° C. In carrying out inkjet recording on an inkjet recording apparatus in practice, it is preferred that the ink temperature be kept at an almost constant temperature between 25° C. and 100° C. and that the viscosity at that time be in the range of from 2 to 50 mPa·s.

The ink is preferably held in a known type of an ink cartridge. The ink may be put in a deformable container to provide an ink tank cartridge as disclosed in JP-A-5-16377. To provide a subtank stabilizes ink feed to a recording head as taught in JP-A-5-16382. The ink cartridge proposed in JP-A-8-174860 that is designed to move a valve so as to maintain stable ink feed even if the ink feed pressure decreases may be used. Methods of creating a negative pressure in such ink holding means to maintain an adequate meniscus in the head include use of the vertical position of the ink holding means, i.e., a water head difference, use of the capillarity of a filter provided in the ink channel, control of the pressure by use of a pump, etc., and use of the capillarity of an ink absorbent in which the ink is held as disclosed in JP-A-50-74341.

The ink can be fed from the ink holding means to a head either directly or via a channel such as a tube. The ink holding means and channel are preferably made of materials having good wettability with ink or materials having been treated to gain such wettability.

There are two types of ink jet recording, either of which is applicable in the invention: (1) continuous ink jet in which ink droplets are continuously ejected and their path is controlled by deflection in response to image information and (2) drop-on-demand ink jet in which ink droplets are ejected in response to image information signals. On-demand ejection mechanisms include a piezoelectric system in which pressure is applied to ink by a piezoelectric element to eject ink droplets (see JP-A-5-16349), a thermal system in which heat is applied to ink to create bubbles whereby to eject an ink droplet (see JP-A-1-234255), and a system in which ink ejection is controlled by an electric field (see JP-A-2001-277466).

Nozzle configurations that can be used in the invention include the one disclosed in JP-A-5-31908. Provision of a plurality of head units having a plurality of nozzle lines makes high speed recording feasible.

A nozzle configuration called line head or full multihead as described, e.g., in JP-A-63-160849 is effective to achieve high speed image formation, in which ink is ejected from a line of nozzles arrayed to at least the width of an image, and a recording medium is moved simultaneously with the ink ejection.

The surface of a nozzle can be subjected to a surface treatment to prevent adhesion of ink droplets or ink mist to its surface as disclosed in JP-A-5-116327. Such a surface treatment can still fail to prevent adhesion of ink and other foreign matter. It is therefore preferred to clean the nozzles by wiping with a blade as proposed in JP-A-6-71904. In case ink is not ejected from nozzles equally, it is preferred to conduct flushing operation (an operation of ejecting ink in a region out of an image-forming region so as to feed fresh ink to the head) as described in JP-A-11-157102. By the flushing operation, the physical ink properties are maintained within proper ranges thereby to stabilize the meniscus. Yet, flushing can still fail to prevent air bubbles from entering the head or generating in the head. In such a case, ink may be sucked up from outside the head to dispose of the ink having changed in physical properties together with air bubbles as described in JP-A-11-334092. When ink ejection is suspended for a longtime, the nozzle surface can be protected by covering with a cap as disclosed in JP-A-11-138830. Despite of these measures, a nozzle can come to fail to eject ink. Image formation with nozzles a part of which does not work results in such problems like uneven image formation. To avoid this, it is effective to detect an ink ejection failure and to take a necessary measure as disclosed in JP-A-2000-343686.

In order to maintain the ink viscosity constant during inkjet recording, it is preferred to maintain the ink temperature constant with a prescribed precision. To achieve this, the inkjet recording system preferably includes ink temperature monitoring means, ink heating means, and control means for controlling the heating in response to the monitored ink temperature. It is also preferred for the recording system to have control means for controlling energy applied to ink ejection means in accordance with the ink temperature.

In an inkjet recording system in which a head unit mechanically moves while a recording medium moves intermittently in synchronization with the movement of the head unit in the direction perpendicular to the head unit moving direction to carry out striking ink droplets in superposition as described in JP-A-6-115099, there is produced the effect of invisualizing unevenness resulting from insufficient precision of the intermittent movement of the recording medium. As a result, high image quality can be realized. In this recording system, the relation among the moving speed of the head, the amount of movement of the medium, and the number of the nozzles can be designed appropriately thereby to establish a preferred relation between the recording speed and image quality. The similar effects are obtained when a recording head is fixed, and a recording medium mechanically moves in prescribed opposite directions and, at the same time, intermittently moves in a direction perpendicular to the first said direction.

The diameter of an ink droplet landed on an ink receptive layer (dot diameter) is preferably between 5 and 500 μm, and thus the diameter of an ink droplet as it is ejected is preferably 5 to 200 μm, and the nozzle diameter is preferably 5 to 200 μm. In platemaking, the volume of an ink droplet ejected is preferably 20 μl or less, still preferably 10 μl or less.

The number of pixels per inch is preferably 50 to 4000 dpi, and thus the nozzle density of a recording head is preferably 10 to 4000 dpi. Even if the nozzle density is low (i.e., the distance between nozzles is large), it is possible to realize a high dot density on a recording medium by tilting the head about the medium's moving direction or by arranging the head units out of alignment with each other. In the case of the above described system in which a head or a recording medium moves reciprocally, high density image recording can be realized by moving the medium by a predetermined amount every time the head moves at a low nozzle pitch thereby to place ink droplets at different positions.

If the head-to-media distance is too large, the ink droplet flight path is disturbed by air flow accompanying the head or media movement, resulting in reduction of dot placement accuracy. If the distance is too short, on the other hand, there is a fear that the head and the medium come into contact due to the surface unevenness of the medium or a vibration of the carriage mechanism. Accordingly, the head-to-media distance is preferably maintained between about 0.5 to 2 mm.

### [V] Photopolymerization of Ink

Light sources that are preferably used in exposing the photopolymerizable ink include generally employed sources such as mercury lamps and metal halide lamps; light emitting diodes, semiconductor lasers, fluorescent lamps; and sources or electromagnetic waves causing photopolymerizable inks to polymerize, such as hot-cathode tubes, cold-cathode tubes, electron beams, and X-rays. In the case of using a mercury lamp or a metal halide lamp, it is preferred to use one having a power of 10 to 3000 W/cm with an illuminance of 1 mW/cm² to 300 W/cm² on the surface of a recording medium. The exposure energy is preferably 0.1 to 1000 mJ/cm². Exposure equipment using a high intensity discharge lamp such as a mercury lamp or a metal halide lamp is preferably equipped with an exhaust unit because the discharge is accompanied by ozone generation. The exhaust unit is preferably installed such that ink mist produced with ink jetting may be collected together with ozone. In the case of a radically polymerizable ink, exposure is preferably performed in a low oxygen condition, i.e., in a nitrogen or like gas atmosphere because presence of oxygen inhibits polymerization. By so doing, ink curing can be accomplished with reduced energy. If an ink ejection nozzle is irradiated with energy for curing, such as light, ink mist adhered to the nozzle surface may cure to interfere with ink ejection. Hence, it is recommended to take some measure, such as light shielding, to minimize irradiation of the nozzle. For example, a partition for preventing a nozzle plate from being irradiated may be provided, or means for limiting the incident angle to the recording medium is provided to reduce stray light.

### [VI] Gumming

The resulting printing plate having an image formed thereon may be subjected to a gumming treatment using a gumming solution containing, for example, gum arabic or a starch derivative and a surface active agent before going on-press. Suitable gumming solutions are described in JP-B-62-16834, JP-B-62-25118, JP-B-63-52600, JP-A-62-7595, JP-A-62-11693, JP-A-62-83194. It is preferred that the ink receptive layer of the nonimage area be dissolved and removed by the gumming solution in this gumming treatment. The lithographic printing plate thus obtained is ready to be used on a lithographic printing machine in a usual manner. The printing plate not having been treated with a gumming solution is also ready to be on a press as well.

### [VII] Fountain Solution (or Dampening Solution)

Any fountain solution that is used in printing on an ordinary lithographic printing plate with an ordinary ink can be used in the invention. Widespread Dahlgren alcohol dampening systems using isopropyl alcohol-containing dampening solutions (isopropyl alcohol content: about 20% to 25%) can be used. Dampening systems having introduced a technique of substitution for isopropyl alcohol are also available, which have been developed because, for one thing, isopropyl alcohol has an inherent unpleasant smell and, for another, isopropyl alcohol is problematical in terms of toxicity and is defined as a second-class organic solvent in Ordinance on Prevention of Organic Solvent Poisoning (The Ministry of Labor, Japan). Techniques of using nonvolatile or high-boiling compounds in place of isopropyl alcohol have also been developed. For example, a fountain solution containing a specific alkylene oxide type nonionic surface active agent and a fountain solution containing an ethylene oxide/propylene oxide adduct of an alkylenediamine are useful.

### EXAMPLES

The present invention will now be illustrated in greater detail with reference to Examples, but it should be understood that the invention is not construed as being limited thereto. Unless otherwise noted, all the percents are by weight.

### Example 1

### Preparation of Support

### Preparation of Aluminum Plate

An aluminum alloy containing Si 0.06%, Fe 0.30%, Cu 0.005%, Mn 0.001%, Mg 0.001%, Zn 0.001%, Ti 0.03%, and the rest of Al and unavoidable impurity was melted. After subjected to molten metal treatment and filtration, the molten metal was cast by a direct chill casting method to obtain ingot measuring 500 mm in thickness and 1200 mm in width. The ingot was scalped to a thickness of 10 mm in average and homogenized at 550° C. for about 5 hours. After the temperature of aluminum plate dropped to 400° C., the plate was rolled to a thickness of 2.7 mm in a hot rolling mill. The rolled plate was heat treated at 500° C. in a continuous annealing furnace and cold-rolled to a thickness of 0.24 mm to obtain an aluminum plate according to JIS 1050. The aluminum plate was cut to a width of 1030 mm.

### Surface Treatment

The aluminum plate was successively subjected to surface treatments (a) to (j) in the order described. The plate was squeegeed between nip rollers after each surface treatment and after washing.

### (a) Mechanical Graining

The aluminum plate was grained with a rotating nylon brush and an aqueous slurry of pumice stone having a specific gravity of 1.12.

### (b) Alkali Etching

The aluminum plate was sprayed with an aqueous solution containing 2.6% caustic soda and 6.5% aluminum ion at 70° C. to etch away 6 g/m² of aluminum. The aluminum plate was then washed with water spray.

### (c) Desmutting

A 1% nitric acid aqueous solution (containing 0.5% aluminum ion) at 30° C. was sprayed to the aluminum plate to carry out desmutting. The aluminum plate was then washed with water spray. The nitric acid aqueous solution used for desmutting was the waste water from the electrochemical graining step (d) (described below) using a nitric acid aqueous solution and an alternating current.

### (d) Electrochemical Graining

The aluminum plate was subjected to electrochemical graining. Electrolysis was continuously conducted using a 50° C., 10.5 g/l aqueous solution of nitric acid (containing 5 g/l aluminum ion and 0.007% ammonium ion) as an electrolyte, a carbon counter electrode, and a 60 Hz alternating voltage. The time Tp required for the electric current to rise from zero to the peak current was 0.8 msec. Trapezoidal wave alternating current was used at a duty ratio of 1:1. Ferrite was used as an auxiliary anode. The current density was 30 A/dm² at the peak. The total quantity of electricity applied to the aluminum plate acting as an anode was 220 C/dm². Five percent of the current from the power source was shunted to the auxiliary anode. After the electrochemical graining, the aluminum plate was washed by water spray.

### (e) Alkali Etching

An aqueous solution containing 26% caustic soda and 6.5% aluminum ion at 32° C. was sprayed to the aluminum plate to etch away 0.25 g/m² of aluminum, thereby to remove the smut mainly comprising aluminum hydroxide resulting from the electrochemical graining (d) and to round off the edges of the pits formed by the electrochemical graining. The aluminum plate was washed by water spray.

### (f) Desmutting

A 15% nitric acid aqueous solution at 30° C. (containing 4.5% aluminum ion) was sprayed onto the aluminum plate to effect desmutting, followed by washing with water spray. The nitric acid solution used for desmutting was the waste water from the electrochemical graining using a nitric acid aqueous solution and alternating electric current.

### (g) Electrochemical Graining

The aluminum plate was subjected to electrochemical graining. Electrolysis was continuously conducted using a 35° C., 7.5 g/l aqueous solution of hydrochloric acid (containing 5 g/l aluminum ion) as an electrolyte, a carbon counter electrode, and a 60 Hz alternating voltage. The time Tp required for the electric current to rise from zero to the peak current was 0.8 msec. Trapezoidal wave alternating current was used at a duty ratio of 1:1. Ferrite was used as an auxiliary anode. The current density was 25 A/dm² at the peak. The total quantity of electricity applied to the aluminum plate acting as an anode was 50 C/dm². The aluminum plate was then washed by water spray.

### (h) Alkali Etching

The aluminum plate was sprayed with an aqueous solution containing 26% caustic soda and 6.5% aluminum ion at 32° C. to etch away 0.20 g/m² of aluminum, thereby to remove the smut mainly comprising aluminum hydroxide resulting from the electrochemical graining (g) and to round off the edges of the pits formed by the electrochemical graining (g). The aluminum plate was then washed with water spray.

### (i) Desmutting

A 25% sulfuric acid aqueous solution (containing 0.5% aluminum ion) at 60° C. was sprayed to the aluminum plate to carry out desmutting. The aluminum plate was then washed with water spray.

### (j) Anodizing

The aluminum plate was subjected to anodizing using sulfuric acid as an electrolyte to form 2.7 g/m² of an anodized layer.

Hydrophilization with Silicate

The resulting aluminum support was immersed in an aqueous solution of water glass (No. 3 according to JIS) at 70° C. for 13 seconds, washed with water, and dried. The resulting support had a surface roughness Ra of 0.55 μm as measured with a profilometer Surfcom 575A from Tokyo Seimitsu Co., Ltd. at a cuff-off length of 0.8 mm over an assessment length of 3 mm. Measurement was taken 5 times to obtain an average Ra.

### Ink Receptive Layer

A coating composition shown in Table 1 below was applied to the support with a wire bar to a dry thickness of 50 mg/m² and dried at 80° C. for 15 seconds to form an ink receptive layer.

TABLE 1

| Function | Kind | Amount | |
|---|---|---|---|
| Water soluble | poly(sodium | 0.25 | g |
| polymer | p-styrenesulfonate)* | | |
| Water soluble | sodium | 0.20 | g |
| compound | dodecylbenzenesulfonate | | |
| Luminescent | disodium | 0.05 | g |
| substance | 4,4′-bis(2-sulfostyryl)bi | | |
| | phenyl | | |
| Surface active agent | TSA-731 (silicone-based | 0.0005 | g |
| (coating aid) | surfactant from Toshiba | | |
| | Silicone) | | |
| | ion exchanged water | 60 | g |
| | methanol | 40 | g |

*Weight average molecular weight: 70000

The ink receptive layer was irradiated with UV light from a black light lamp, and luminescence of the luminescent substance was observed with the naked eye. The luminescence was uniform, indicating no coating unevenness.

### Preparation of Radiation Curable Ink

A radiation curable ink was prepared according to the following composition.

TABLE 2

| Function | Kind | Amount (g) |
|---|---|---|
| Pigment | carbon black pigment | 4 |
| Dispersant for | Solsperse 32000 (from Avecia) | 1 |
| pigment | | |
| Initiator | diphenyl (2,4,6-trimethylbenzoyl) | 5 |
| | phosphine oxide | |
| Initiator | hydroxycyclohexyl phenyl ketone | 5 |
| Sensitizer | 2,4-diethylthioxanthone | 5 |
| Monomer | triethylene glycol divinyl ether | 20 |
| Monomer | dipropylene glycol diacrylate | 60 |
| Monomer | 1,6-hexanediol diacrylate | 35 |
| Monomer | trimethylolpropane triacrylate | 65 |
| Inhibitor | tris (N-nitroso-N-phenylhydroxy- | 0.01 |
| | aminato) aluminum | |
| F-containing | P-1 (see below) | 1.0 |
| compound | | |

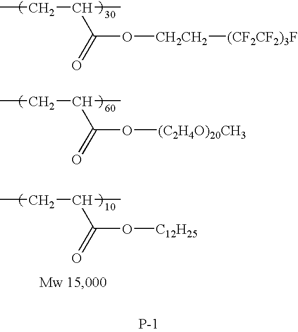

### Ink Jet Recording

An image was inkjet recorded on the ink receptive layer using the radiation curable ink.

A head scanning inkjet printer having one shear mode piezo head CA3 from Toshiba Tec Corp. (minimum droplet volume: 6 μl; number of nozzles: 318; nozzle density: 150 nozzles/25.4 mm) mounted on a movable printer carriage was used. The ink was put in a 2-liter ink tank capable of applying reduced pressure, degassed under reduced pressure of −40 kPa to be freed of dissolved gas, and led to the head via a hydrostatic pressure control tank (capacity: 50 ml) and a polytetrafluoroethylene soft tube (inner diameter: 2 mm). The inner pressure of the head was adjusted to −6.6 kPa by controlling the position of the hydrostatic pressure tank with respect to the head, whereby the meniscus at the nozzles was controlled. The ink temperature in the head was maintained at 45° C. by means of a water circulator thermostat CH-201 from Scinics Corp. The head was driven at a voltage of 24 V to eject ink in an 8-level multidrop mode or a binary mode at a dot frequency of 4.8 kHz or 12 kHz, respectively. The pixel pitch was 600 dpi in the head scanning direction (scanning speed: 203 mm/s) multiplied by 600 dpi in the media moving direction in the case of multidrop mode or 1200 dpi in the heat scanning direction (scanning speed: 254 mm/s) multiplied by 600 dpi in the media moving direction. That is, the printer recorded an image in a 2 pass interlaced mode while serially moving the lithographic printing plate precursor. The printer had head cleaning means comprising a nonwoven fabric with which the nozzle plate of the head was wiped in a non-contact mode.

### Exposure

Within one to 60 seconds from the image formation by inkjet recording, the lithographic printing plate precursor having the image recorded thereon was exposed to light of a high pressure mercury lamp (3 kW) to obtain a lithographic printing plate.

### Evaluation of Print

The resulting lithographic printing plate was mounted on a printing press Lithrone from Komori Corp., and printing was performed using a fountain solution IF102 from Fuji Photo Film and an ink DIC-GEOS(N) Sumi from Dainippon Chemicals & Ink. As a result, contamination of the fountain solution did not occur, and prints with no ink smearing on the nonimage area were obtained.

### Example 2

The same procedures as in Example 1 were followed, except for using disodium 4,4′-bis{(4-anilino-6-morpholio-1,3,5-triazin-2-yl) amino}stilbene 2,2′-disulfonate as a luminescent substance in the ink receptive layer. When the ink receptive layer was irradiated with UV light from a black light lamp, the luminescence of the luminescent substance was uniform as observed with the naked eye, showing no coating unevenness. As a result of lithographic printing, no contamination of the fountain solution was observed, and prints free from ink smearing on the nonimage area were obtained.

### Example 3

The same procedures as in Example 1 were followed, except for using sodium 9,10-dimethoxyanthracene 1-sulfonate as a luminescent substance in the ink receptive layer. When the ink receptive layer was irradiated with UV light from a black light lamp, the luminescence of the luminescent substance was uniform as observed with the naked eye, showing no coating unevenness. As a result of lithographic printing, no contamination of the fountain solution was observed, and prints free from ink smearing on the nonimage area were obtained.

### Comparative Example 1

The same procedures as in Example 1 were followed, except for replacing the luminescent substance in the ink receptive layer with Acid Violet 34, a non-luminescent dye. When the ink receptive layer was irradiated with UV light from a black light lamp, the coloring by the dye was uniform as observed with the naked eye, displaying no coating unevenness. As a result of lithographic printing, however, the fountain solution was contaminated by the dissolved dye.

This application is based on Japanese Patent application JP 2006-249111, filed Sep. 14, 2006, the entire content of which is hereby incorporated by reference, the same as if fully set forth herein.

Although the invention has been described above in relation to preferred embodiments and modifications thereof, it will be understood by those skilled in the art that other variations and modifications can be effected in these preferred embodiments without departing from the scope and spirit of the invention.

What is claimed is:

1. A lithographic printing plate precursor on which an image is adapted to be formed with an inkjet ink by inkjet recording,
comprising a support and an ink receptive layer containing a luminescent substance.

2. The lithographic printing plate precursor according to claim 1, wherein the ink receptive layer further contains a water soluble polymer.

3. The lithographic printing plate precursor according to claim 1, wherein the ink receptive layer contains from 0.01% to 90% by weight of the luminescent substance.

4. The lithographic printing plate precursor according to claim 1, wherein the ink receptive layer contains from 0.1% to 70% by weight of the luminescent substance.

5. The lithographic printing plate precursor according to claim 1, wherein the ink receptive layer contains from 0.5% to 50% by weight of the luminescent substance.

6. The lithographic printing plate precursor according to claim 2, wherein the water soluble polymer has water solubility of 1 g or more in 100 g of water at 25° C.

7. The lithographic printing plate precursor according to claim 2, wherein the water soluble polymer has a weight average molecular weight of 1000 or more.

8. The lithographic printing plate precursor according to claim 6, wherein the water soluble polymer has a weight average molecular weight of 1000 or more.

9. The lithographic printing plate precursor according to claim 2, wherein the water soluble polymer has a weight average molecular weight of from 3000 to 1,000,000.

10. A lithographic printing plate comprising the lithographic printing plate precursor as claimed in claim 1 and an image formed thereon with an inkjet ink by inkjet jet recording.

11. A process for making a lithographic printing plate, comprising: forming an image on the lithographic printing plate precursor as claimed in claim 1 with an inkjet ink by inkjet recording.

12. A method for inspecting a surface condition of the lithographic printing plate precursor as claimed in claim 1, comprising: irradiating the lithographic printing plate precursor with light causing the luminescent substance to emit light; and receiving the emitted light.
